(19) United States
(12) Patent Application Publication
(10) Pub. No.: US 2022/0084002 A1
(43) Pub. Date: Mar. 17, 2022

(54) SALES DATA PROCESSING DEVICE, SALES DATA PROCESSING METHOD AND RECORDING MEDIUM

(71) Applicant: CASIO COMPUTER CO., LTD., Tokyo (JP)

(72) Inventor: Katsuhiko MOTOIKE, Sagamihara-shi (JP)

(73) Assignee: CASIO COMPUTER CO., LTD., Tokyo (JP)

(21) Appl. No.: 17/407,104

(22) Filed: Aug. 19, 2021

(30) Foreign Application Priority Data
Sep. 15, 2020 (JP) 2020-154203

(51) Int. Cl. G06Q 20/20; G06Q 20/40

(52) U.S. Cl. CPC G06Q 20/20; G06Q 20/401

(57) ABSTRACT

A sales data processing device includes at least one processor that executes a program stored in memory. The processor registers sales, and tries to transmit sales registration information of a registered transaction to an external terminal via a communicator based on timing of closing operation for the transaction. The processor determines whether the sales registration information of the transaction is successfully transmitted. In a case where the processor determines that transmission of the sales registration information of the transaction has failed, the processor tries again to transmit the sales registration information of the transaction to the external terminal via the communicator based on timing of closing operation of a subsequent transaction.

### CROSS REFERENCE TO RELATED APPLICATION

This application is based upon and claims the benefit of priority under 35 USC 119 of Japanese Patent Application No. 2020-154203 filed on Sep. 15, 2020, the entire disclosure of which, including the description, claims, drawings and abstract, is incorporated herein by reference in its entirety.

### BACKGROUND

### 1. Technical Field

The present invention relates to a sales data processing device, a sales data processing method and a recording medium.

### 2. Background Art

As described in JP 2015-87822A, a conventionally known POS terminal transmits sales registration information for each transaction to a computer system at an upper level.

In a case where a communication error (communication failure) happens in transmission of the sales registration information, the error is solved by retry communication (retransmission).

### SUMMARY OF INVENTION

According to an aspect of the present invention, a sales data processing device includes:
at least one processor that executes a program stored in memory, wherein
the at least one processor:
registers sales;
tries to transmit sales registration information of a registered transaction to an external terminal via a communicator based on timing of closing operation for the transaction; and
determines whether the sales registration information of the transaction is successfully transmitted, and
in a case where the at least one processor determines that transmission of the sales registration information of the transaction has failed, the at least one processor tries again to transmit the sales registration information of the transaction to the external terminal via the communicator based on timing of closing operation of a subsequent transaction.

According to another aspect of the present invention, a sales data processing method for a sales data processing device includes:
registering sales;
trying to transmit registered sales registration information of a transaction to an external terminal via a communicator based on timing of closing operation for the transaction;
determining whether the sales registration information of the transaction is successfully transmitted; and
in a case where it is determined that transmission of the sales registration information of the transaction has failed, trying again to transmit the sales registration information of the transaction to the external terminal via the communicator based on timing of closing operation of a subsequent transaction.

According to still another aspect of the present invention, a non-transitory computer-readable recording medium stores a program that makes at least one processor of a sales data processing device:
register sales;
try to transmit sales registration information of a registered transaction to an external terminal via a communicator based on timing of closing operation for the transaction;
determine whether the sales registration information of the transaction is successfully transmitted; and
in a case where the at least one processor determines that transmission of the sales registration information of the transaction has failed, try again to transmit the sales registration information of the transaction to the external terminal via the communicator based on timing of closing operation of a subsequent transaction.

### BRIEF DESCRIPTION OF DRAWINGS

The advantages and features provided by embodiments of the invention will become more fully understood from the detailed description given hereinbelow and the appended drawings which are given by way of illustration only, and thus are not intended as a definition of the limits of the present invention.

FIG. 1 shows an example of configuration of a sales data management system.

FIG. 2 shows appearance of a sales data processing device.

FIG. 3 is a block diagram showing functional configuration of the sales data processing device.

FIG. 4 shows an example of a table of the number of retries for each period.

FIG. 5 is a block diagram showing functional configuration of a mobile terminal.

FIG. 6 shows an example of a communication setting screen displayed on the mobile terminal.

FIG. 7 is a flowchart showing a flow of sales registration information transmission processing executed by the sales data processing device.

FIG. 8A shows an example of a screen of a customer display during sales registration.

FIG. 8B shows an example of a screen of the customer display during communication in progress.

FIG. 9 is a flowchart showing a flow of calculation of the number of remaining retries executed in Steps S8 and S14 of FIG. 7.

### DESCRIPTION OF EMBODIMENTS

Hereinafter, embodiments of the present invention will be described with reference to the drawings. However, the scope of the invention is not limited to the disclosed embodiments.

### Configuration of Sales Data Management System

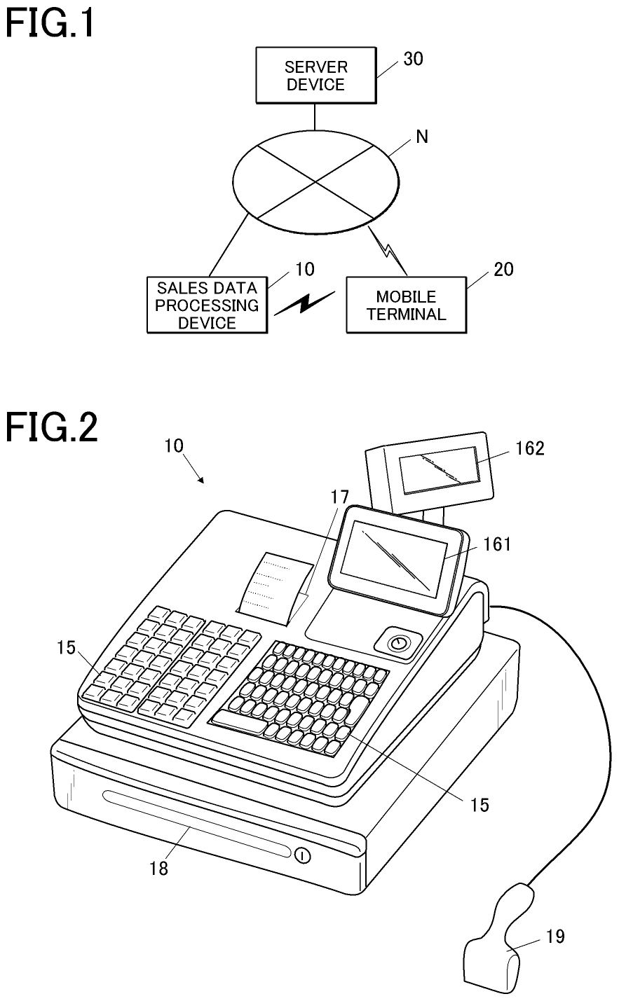

FIG. 1 shows configuration of a sales data management system 100 of an embodiment.

The sales data management system 100 includes a sales data processing device 10, a mobile terminal 20, and a server device 30. The sales data processing device 10 and the mobile terminal 20 transmit and receive data by short-range wireless communication in BLE (Bluetooth (registered trademark) Low Energy). The sales data processing device 10, the mobile terminal 20, and the server device 30 are connected to a communication network N such as a LAN (local area network) or the Internet. They send and receive data to and from external devices connected to the communication network N.

The numbers of the sales data processing devices 10 and the mobile terminals 20 are not limited.

The sales data processing device 10 is an ECR (electronic cash register) or the like installed in a store. The sales data processing device 10 registers sales of transactions of goods and services in response to input operation of a user (operator of the sales data processing device 10). The sales data processing device 10 transmits registered sales registration information for each transaction to the mobile terminal 20.

The mobile terminal 20 is a portable information terminal such as a mobile phone or a tablet. The mobile terminal 20 receives the sales registration information transmitted from the sales data processing device 10 and transmits it to the server device 30.

The server device 30 includes memory constituted by an HDD (hard disk drive), an SSD (solid state drive), and the like. The server device 30 receives, stores, and manages the sales registration information of the sales data processing device 10 transmitted from the mobile terminal 20.

### Configuration of Sales Data Processing Device

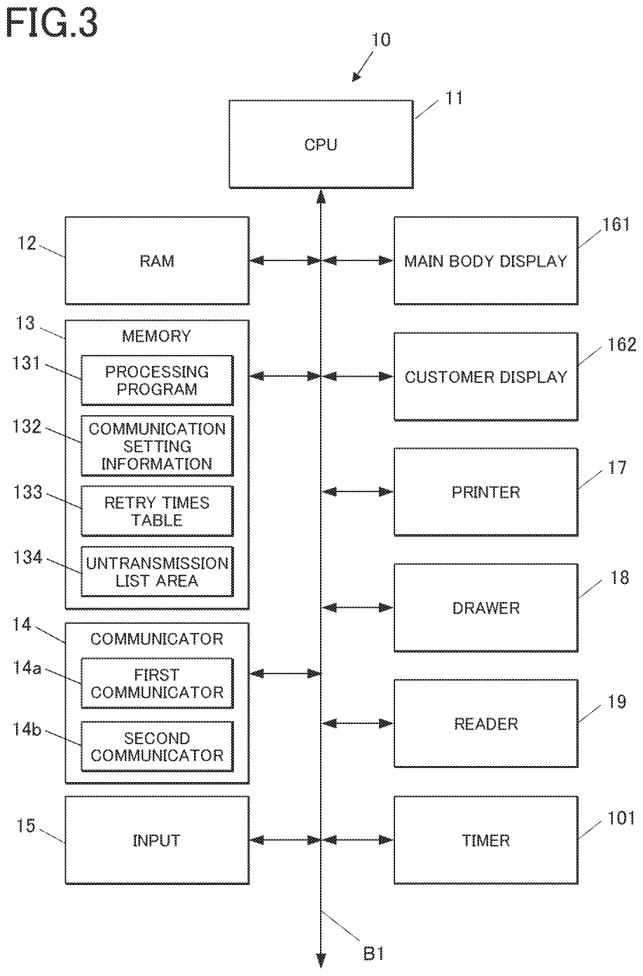

FIG. 2 shows appearance of the sales data processing device 10. FIG. 3 is a block diagram showing functional configuration.

The sales data processing device 10 includes a CPU (central processing unit) 11, RAM (random access memory) 12, memory 13, a communicator 14, an input 15, a main body display 161, a customer display 162, a printer 17, a drawer 18, a reader 19, and a timer 101. The parts of the sales data processing device 10 are connected by a bus B1.

The CPU 11 is a processor that controls the parts of the sales data processing device 10. The CPU reads programs stored in the memory 13 and develops them in the RAM 12. The CPU 11 executes the programs and performs arithmetic processing of various kinds.

The RAM 12 provides the CPU 11 with a working memory space and temporarily stores data. The RAM 12 may include non-volatile memory.

The memory 13 is constituted by semiconductor non-volatile memory or the like such as flash memory. The memory 13 stores a system program and a processing program 131 executed by the CPU 11, data necessary for executing these programs, and the like. The processing program 131 includes programs for executing processing of various kinds such as sales registration information transmission processing described later. These programs are stored in the memory 13 in forms of computer-readable program code. The CPU 11 executes operations according to the program code one by one.

The memory 13 stores communication setting information 132 and a retry times table 133.

The communication setting information 132 is information of a communication setting for transmission of sales registration information to the mobile terminal 20.

The communication setting information 132 includes at least:

the number of retries in a case where a communication error (communication failure) happens in transmission of sales registration information to the mobile terminal 20; and

whether to avoid retries in busy time.

Avoiding retries in busy time means reducing the number of retries in busy periods.

The retry times table 133 is referred to for determining the number of retries in a case where execution of avoidance of retries in busy time is set. At least the number of retries for each period is stored in the retry times table 133.

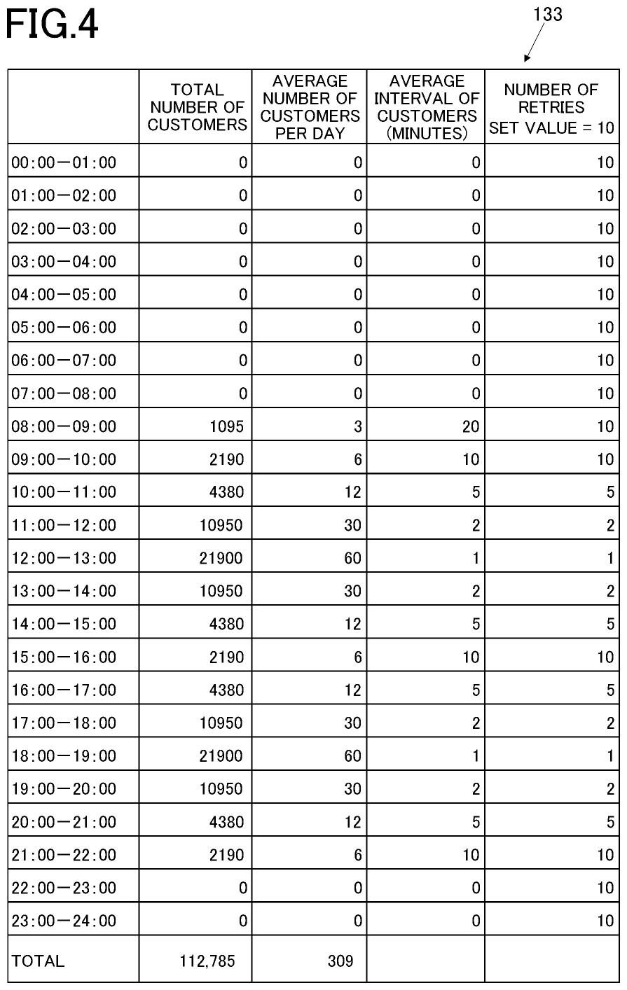

FIG. 4 shows an example of the retry times table 133. In the retry times table 133, the number of retries for each period is set such that a smaller number of retries is set for a busy period in which the number of customers is larger. The setting is based on busy status of respective periods at a store where the sales data processing device 10 is installed, for example, statistical data of the number of customers (or transactions) in the past at the store where the sales data processing device 10 is installed. In the retry times table 133, the number of retries is set according to, for example, an average customer interval in each period, which is calculated from an average number of people in each period per day as shown in FIG. 4. The average number of customers in each period per day is calculated from the total number of customers in each period over the past year. For example, the number of transactions for which sales is registered is regarded as the number of customers. In FIG. 4, if the average customer interval is a predetermined time or more (in the example, ten minutes or more), the number of retries set in the communication setting information 132 is set. If the average customer interval is less than the predetermined time, the number of retries is set such that, the shorter the average customer interval (the larger the number of customers), the smaller the number of retries.

In order to set the number of retries for each period, the number of customers for each period may be classified into several levels, for example:
an average of less than 10 people per day (first level);
an average of 10 to 20 people (second level);
an average of 21 to 30 people (third level);
an average of 31 to 59 people (fourth level); and
an average of more than 60 people (fifth level).

The number of retries is set according to the levels. A smaller number of times is set for a period in which the number of customers is larger. In the case where the number of customers is classified into the above five levels, the maximum number of times is set for a period of the first level. The minimum number of times is set for a period of the fifth level.

The memory 13 includes an untransmission list area 134 that stores sales registration information which has not been transmitted.

The communicator 14 includes a first communicator 14a and a second communicator 14b.

The first communicator 14a communicates with external devices such as a mobile terminal 20 by short-range wireless communication in a communication method of Bluetooth Low Energy (BLE).

The second communicator 14b performs data communication with external devices such as the server device 30 via the communication network N.

The input 15 includes mode keys (registration key, adjustment key, check key, setting key) for setting operation modes, number keys, and various function keys. The input 15 accepts key input by a user and outputs operation information to the CPU 11. The input 15 accepts key input to number keys, a subtotal key, or the like at the time of sales registration, for example.

The main body display 161 is a display device for an operator such as a clerk who operates the sales data processing device 10 to visually recognize information such as an amount of goods or services traded and the total amount of money. The main body display 161 is constituted by an LCD (liquid crystal display), an EL (electro luminescent) display, or the like. The main body display 161 displays various display information on a display screen under the control of the CPU 11.

The customer display 162 is a display device for customers to visually recognize information such as an amount of goods or services traded and the total amount of money. The customer display 162 is constituted by an LCD, an EL display, or the like. The customer display 162 displays various display information on a display screen under the control of the CPU 11.

The printer 17 prints a receipt, a journal, or the like on a sheet in accordance with a control signal output from the CPU 11, and outputs the receipt or journal.

The drawer 18 is for storing money, gift vouchers, and the like. The drawer 18 includes an opening mechanism that opens under the control of the CPU 11.

The reader 19 is constituted by a laser scanner, an image scanner, or the like. The reader 19 reads code information such as a bar code and a two-dimensional code, and outputs the code information to the CPU 11.

The timer 18 includes a timer circuit such as an RTC (real time clock). The timer 18 clocks the current time and the current date, and outputs them to the CPU 11.

### Configuration of Mobile Terminal

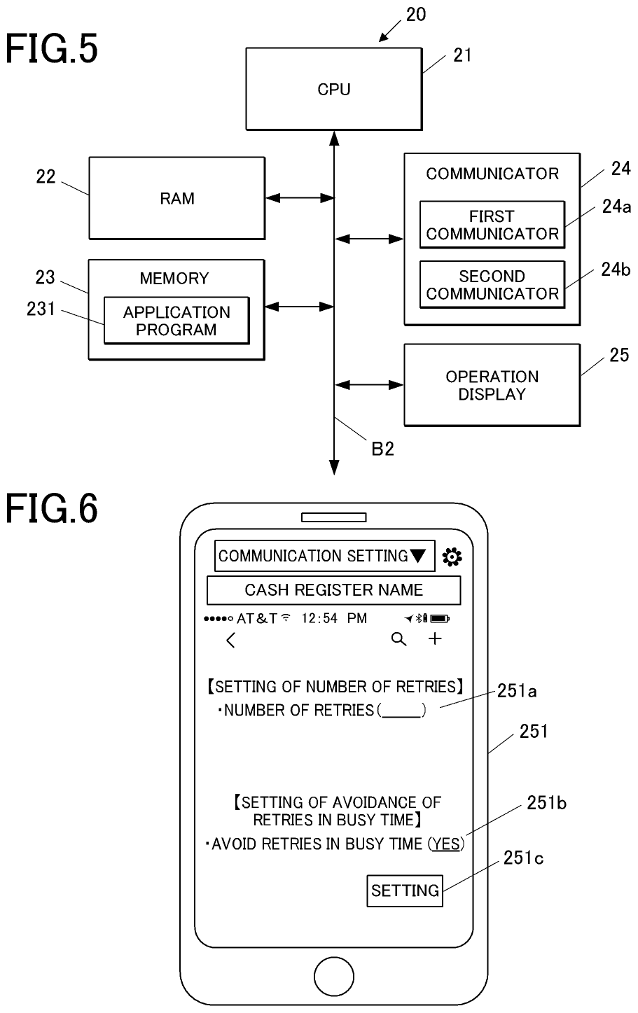

FIG. 5 is a block diagram showing functional configuration of the mobile terminal 20.

The mobile terminal 20 includes a CPU 21, RAM 22, memory 23, a communicator 24, and an operation display 25. The parts of the mobile terminal 20 are connected by a bus B2.

The CPU 21 is a processor that controls the parts of the mobile terminal 20. The CPU 21 reads a program (such as an application program 231) stored in the memory 23, and develops it in the RAM 22. The CPU 21 executes the program and performs arithmetic processing of various kinds.

The RAM 22 provides the CPU 21 with a working memory space, and temporarily stores data. The RAM 22 may include non-volatile memory.

The memory 23 is constituted by semiconductor non-volatile memory or the like such as flash memory. The memory stores system programs and application programs 231 executed by the CPU 21, data necessary for executing these programs, and the like. The application program 231 is a program for linking with the sales data processing device 10.

Specifically, the application program 231 is a program for executing processing of:
making communication settings for the sales data processing device 10; and
transmitting sales registration information transmitted from the sales data processing device 10 to the server device 30.

The memory 23 stores these programs in forms of computer-readable program code. The CPU 21 executes operations according to the program code one by one.

The communicator 24 includes a first communicator 24a and a second communicator 24b.

The first communicator 24a communicates with external devices such as the sales data processing device 10 by short-range wireless communication in a communication method of Bluetooth Low Energy (BLE).

The second communicator 14b performs data communication with external devices such as the server device 30 via the communication network N.

The operation display 25 includes:
a display such as an LCD or an organic EL display; and
a touch panel piled on a display screen of the display.

The operation display 25 may further include an input device that accepts input operation from an operator in addition to the touch panel.

### Operation of Sales Data Management System

Next, operation of the sales data management system 100 will be described.

The application program 231 is started on the mobile terminal 20. Then, the CPU 21 of the mobile terminal 20 makes the first communicator 24a request the sales data processing device 10 for connection in BLE communication. Connection is established.

It allows:
processing of setting communication setting information from the mobile terminal 20 to the sales data processing device 10 (communication setting processing); and
processing of transmitting sales registration information for each transaction which is registered in the sales data processing device 10 to the mobile terminal 20 (sales registration information transmission processing).

### Communication Setting Processing

First, the communication setting processing will be described.

As described above, the sales data processing device 10 stores the communication setting information 132 and the retry times table 133. A user can change the communication setting information 132 from the mobile terminal 20 at any time by the communication setting processing.

The communication setting processing is started when:
the application program 231 is started on the mobile terminal 20; and
a communication setting is selected from a menu.

In the communication setting processing, the CPU 21 first displays a communication setting screen 251 on the operation display 25.

FIG. 6 shows an example of the communication setting screen 251.

As shown in FIG. 6, the communication setting screen 251 includes an input field 251a for the number of retries, an input field 251b for a setting of avoidance of retries in busy time, and a setting button 251c. The input field 251a for the number of retries is an area for inputting the number of retries for transmission of the sales registration information from the sales data processing device 10 to the mobile terminal 20. The input field 251b for the setting of avoidance of retries in busy time is an area for inputting whether to avoid retries in busy time. The number of retries is input in the input field 251a for the number of retries. Whether to avoid retries in busy time is input in the input field 251b for the setting of avoidance of retries in busy time. The setting button 251c is pressed. Then, the CPU 21 makes the first communicator 24a transmit the communication setting information to the sales data processing device 10. The communication setting information is information on the number of retries and the setting of avoidance of retries in busy time.

The sales data processing device 10 receives the communication setting information from the mobile terminal 20 by the first communicator 14a. Then, the CPU 11 updates the communication setting information 132 stored in the memory 13 according to the received communication setting information.

In a case where the setting of avoidance of retries in busy time of the received communication setting information is set to “Yes”, the CPU 11 updates the number of retries for each period in the retry times table 133 based on the number of retries in the received communication setting information.

For example, the server device 30 calculates the total number of customers for each period in one year based on the sales registration information stored in the memory for each predetermined term. The predetermined term is, for example, a quarter, half a year, or one year. The number of customers is estimated from, for example, the number of transactions. The server device 30 transmits the total to the sales data processing device 10. The CPU 11 receives the total number of customers in one year for each period from the server device 30 by the second communicator 14b. Then, the CPU 11 calculates an average number of customers per day and an average customer interval for each period based on the received total number of customers. The CPU 11 updates the retry times table 133. The server device 30 may calculate the average number of customers per day and the average customer interval for each period based on the total number of customers in one year for each period, and transmit it to the sales data processing device 10. A busy period is updated based on recent statistical data.

That is, busy status of respective periods is derived based on sales registration information of the predetermined term.

The numbers of transactions or customers in past periods are derived based on the sales registration information of the predetermined term.

In the above example, the retry times table 133 is updated based on statistical data of the number of customers in one year. Alternatively, the retry times table 133 may be updated based on statistical data of the number of customers in a predetermined term, for example, a quarter or half a year.

### Sales Registration Information Transmission Processing

Next, the sales registration information transmission processing of transmitting the sales registration information for each transaction registered in the sales data processing device 10 to the mobile terminal 20 will be described.

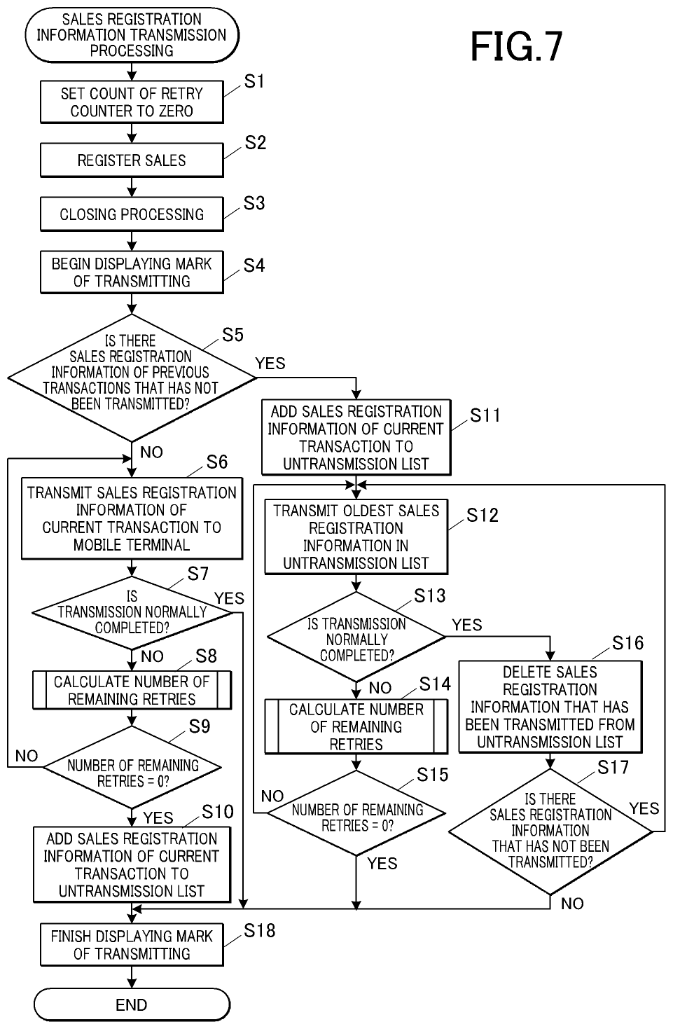

FIG. 7 is a flowchart showing a flow of the sales registration information transmission processing for each transaction. While the sales data processing device 10 is operating in a registration mode, the CPU 11 executes the sales registration information transmission processing. The CPU 11 cooperates with the processing program 131 to execute the sales registration information transmission processing.

First, the CPU 11 provides a retry counter in the RAM 12 and sets the count at 0 (Step S1).

Next, the CPU 11 accepts sales registration of goods or services that are traded (Step S2).

Sales registration is performed by, for example:
operation on the input 15 by a clerk; or
reading a bar code on a product or the like with the reader 19.

The sales registration information (product name (service name), quantity, amount, tax information, etc.) is temporarily stored in the RAM 12. A price, etc. of registered goods and services are displayed on the main body display 161 and the customer display 162.

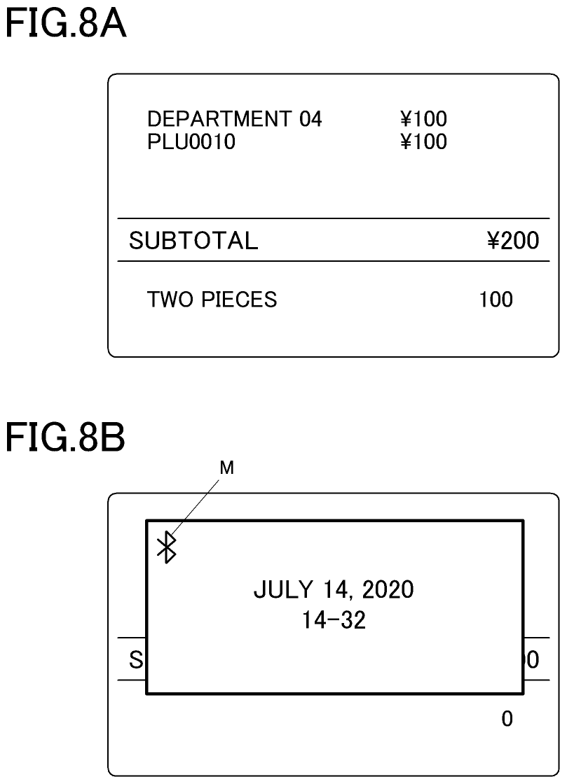

FIG. 8A shows an example of a screen during sales registration displayed on the main body display 161.

Sales registration is completed, and closing operation, such as press on a subtotal button in the input 15, is performed. Then, the CPU 10 executes closing processing (Step S3).

In the closing processing, the CPU 10 executes, for example:
calculation of a total amount (total transaction amount);
calculation of discount and reduction;
acceptance of registration of closing type (cash, gift voucher, or credit) and deposits; and
calculation of change.

The CPU 10 generates sales registration information for the current transaction and makes the printer 17 print a receipt.

The sales registration information includes, for example:

information that identifies a transaction (transaction time and date, and receipt number);
detailed information of a purchased product (product name, quantity, amount, and tax information which shows a tax rate of 10%, a reduced tax rate, and exemption);
additional information (discount, reduction, discount coupon numbers, etc.); and
payment information (closing amount and closing type, such as cash, gift voucher, and credit).

When the closing processing is completed, the CPU 11 begins displaying a mark indicating that communication is in progress on the main body display 161 (Step S4).

FIG. 8B shows an example of a screen of transmitting which is displayed on the main body display 161. As shown in FIG. 8B, a mark M or the like indicating that communication is in progress is displayed on the screen of transmitting.

Next, the CPU 11 refers to the untransmission list area 134 in the memory 13. The CPU 11 determines whether there is sales registration information of previous transactions which has not been transmitted to the mobile terminal 20 (Step S5).

In a case where the CPU 11 determines that there is no sales registration information that has not been transmitted (NO in Step S5), the CPU 11 makes the first communicator 14a transmit sales registration information of the current transaction to the mobile terminal 20 (Step S6).

Next, the CPU 11 determines whether transmission of the sales registration information is normally completed (Step S7).

In a case where the CPU 11 determines that transmission of the sales registration information is normally completed (YES in Step S7), the CPU 11 proceeds to Step S18.

Thus, after the closing processing, the sales registration information of the current transaction is transmitted to the mobile terminal 20. It prevents sales registration information from occupying the memory too much.

In a case where the CPU 11 determines that transmission of the sales registration information is not normally completed (NO in Step S7), the CPU 11 calculates the number of remaining retries (Step S8).

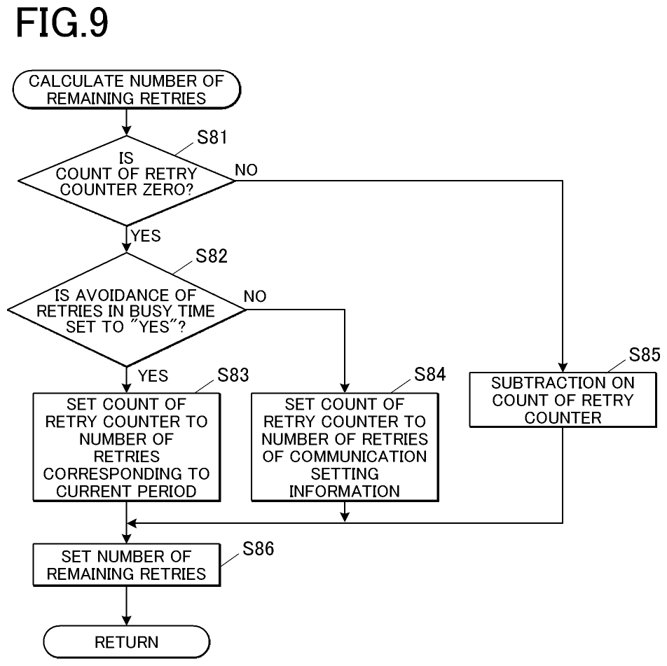

FIG. 9 is a flowchart showing a flow of calculation of the number of remaining retries executed in Step S8 of FIG. 7.

First, the CPU 11 determines whether a count of the retry counter is zero (Step S81).

In a case where the CPU 11 determines that the count of the retry counter is zero (YES in Step S81), the CPU 11 refers to the communication setting information 132 and determines whether avoidance of retries in busy time is set to “Yes” (Step S82).

In a case where the CPU 11 determines that the avoidance of retries in busy time is set to “Yes” (YES in Step S82), the CPU 11 refers to the retry times table 133. The CPU 11 sets the count of the retry counter to the number of retries corresponding to a period of the current time (Step S83). The CPU 11 proceeds to Step S86.

In a case where the CPU 11 determines that the avoidance of retries in busy time is set to “No” (NO in Step S82), the CPU 11 sets the count of the retry counter to the number of retries of the communication setting information 132 (Step S84). The CPU 11 proceeds to Step S86.

On the other hand, in a case where the CPU 11 determines in Step S81 that the count of the retry counter is not zero (NO in Step S81), the CPU 11 subtracts 1 from the count of the retry counter (Step S85). The CPU 11 proceeds to Step S86.

In Step S86, the CPU 11 sets the count of the retry counter to the number of remaining retries (Step S86). The CPU 11 proceeds to Step S9 in FIG. 5.

In Step S9 of FIG. 5, the CPU 11 determines whether the number of remaining retries is zero (Step S9).

In a case where the CPU 11 determines that the number of remaining retries is not zero (NO in Step S9), the CPU 11 returns to Step S6 and retries transmission of the sales registration information.

In a case where the CPU 11 determines that the number of remaining retries is zero (YES in Step S9), the CPU 11 adds sales registration information of the current transaction to the untransmission list area 134 (Step S10). The CPU 11 proceeds to Step S18.

On the other hand, in a case where the CPU 11 determines in Step S5 that there is sales registration information of previous transactions which has not been transmitted to the mobile terminal 20 (YES in Step S5), the CPU 11 adds sales registration information of the current transaction to the untransmission list area 134 (Step S11). The CPU 11 makes the first communicator 14a transmit the oldest sales registration information (sales registration information with the oldest transaction date) stored in the untransmission list area 134 to the mobile terminal 20 (Step S12).

Next, the CPU 11 determines whether transmission of sales registration information by the first communicator 14a is normally completed (Step S13).

In a case where the CPU 11 determines that transmission of sales registration information is not normally completed (NO in Step S13), the CPU 11 calculates the number of remaining retries (Step S14).

Processing of Step S14 is the same as that of Step S8 in FIG. 7. Explanation is omitted.

After calculating the number of remaining retries, the CPU 11 determines whether the number of remaining retries is zero (Step S15).

In a case where the CPU 11 determines that the number of remaining retries is not zero (NO in Step S15), the CPU 11 returns to Step S12 and retries transmission of sales registration information.

In a case where the CPU 11 determines that the number of remaining retries is zero (YES in Step S15), the CPU 11 proceeds to Step S18.

On the other hand, in a case where the CPU 11 determines in Step S13 that transmission of the sales registration information is normally completed (YES in Step S13), the CPU 11 deletes the sales registration information that has been transmitted from the untransmission list area 134 (Step S16). The CPU 11 determines whether there is sales registration information that has not been transmitted in the untransmission list area 134 (Step S17).

In a case where the CPU 11 determines that there is sales registration information that has not been transmitted in the untransmission list area 134 (YES in Step S17), the CPU 11 returns to Step S12.

In a case where the CPU 11 determines that there is no sales registration information that has not been transmitted in the untransmission list area 134 (NO in Step S17), the CPU 11 proceeds to Step S18.

In Step S18, the CPU 11 finishes displaying the mark indicating that communication is in progress on the main body display 161 (Step S18). The CPU 11 ends the sales registration information transmission processing.

The CPU 21 of the mobile terminal 20 receives sales registration information from the sales data processing device 10 by the first communicator 24a. Then, the CPU 21 makes the second communicator 24b transmit the received sales registration information to the server device 30.

As described above, the CPU 11 of the sales data processing device 10 makes the first communicator 14a try to transmit sales registration information of a transaction for which sales are registered to the mobile terminal 20 based on timing of closing operation of the transaction. Then, the CPU 11 determines whether transmission of the sales registration information of the transaction is successful. In a case where the CPU 11 determines that transmission of the sales registration information of the transaction has failed, the CPU 11 makes the first communicator 14a try again to transmit the sales registration information of the transaction to the mobile terminal 20 based on timing of closing operation of a subsequent transaction.

It reduces waiting time of customers lining at a cash register in the case where transmission of sales registration information after closing operation fails.

For example, in a case where the CPU 11 determines that transmission of the sales registration information for the transaction for which sales are registered has failed, the CPU 11 retries transmission (retransmission). In a case where the CPU 11 determines that retransmission of the preset number of retries has failed, the CPU 11 ends retransmission. The CPU 11 makes the first communicator 14a try again to transmit the sales registration information of the transaction to the mobile terminal 20 based on timing of closing operation of a subsequent transaction. Therefore, in a case where a communication status is restored immediately, sales registration information is transmitted immediately. On the other hand, in a case where communication status is poor and transmission continues to fail, waiting time for customers lining at a cash register is reduced.

The preset number of retries is set for each period. In a case where the CPU 11 determines that retries of the number of times corresponding to a period in which a transaction is performed have failed, the CPU 11 ends retries. It makes it possible to change the number of retries according to periods.

For example, the number of retries for each period is set according to busy status of respective periods. The number of retries can be changed according to busy status of a store. It prevents retries from interfering with operation of a store.

For example, the number of retries for each period is set according to the numbers of transactions or customers in past periods at a store where the sales data processing device 10 is installed. It allows retries of the number of times corresponding to busy status of respective periods.

For example, a smaller number of retries is set for a period in which the number of transactions or customers is larger. The number of retries in a busy period is reduced. Retries do not interfere with operation of a store.

For example, in order to set the number of retries for each period, the number of transactions or customers for each period may be classified into several levels. The number of retries is set according to the levels. A smaller number of times is set for a period in which the number of transactions or customers is at a higher level. The number of retries in a busy period is reduced. Retries do not interfere with operation of a store.

In a case where pieces of sales registration information of previous transactions have not been transmitted, before transmitting sales registration information of a transaction currently registered, the CPU performs control to transmit the pieces of sales registration information of the previous transactions one by one from oldest to newest. It allows pieces of sales registration information of transactions to be transmitted one by one from oldest to newest.

The CPU 21 of the mobile terminal 20 receives sales registration information from the sales data processing device 10 by the first communicator 24a. Then, the CPU 21 makes the second communicator 24b transmit the received sales registration information to the server device 30.

The server device 30 can store and manage the sales registration information registered in the sales data processing device 10.

The present invention is described above based on the embodiments. The present invention is not limited to the above embodiments, and can be modified within the scope of the claims.

For example, in the above embodiment, the number of retries according to the numbers of customers based on the numbers of transactions in past periods are set in the retry times table 133. The retry times table 133 is not limited to this. The number of customers in each period in the past at a store may be stored. The number of retries for each period is set according to the numbers of customers in past periods.

The number of retries may be set to zero. No retries are made after transmission fails.

In the above embodiment, communication between the sales data processing device 10 and the mobile terminal 20 is performed by BLE communication. Alternatively, other communication methods, such as Wi-Fi, may be used.

In the above examples, a hard disk, semiconductor non-volatile memory, or the like is used as a computer-readable medium storing a program according to the present invention. The medium is not limited to the examples. A portable recording medium such as CD-ROM may also be applied as the computer-readable medium. A carrier wave may also be applied as a medium that provides data of a program according to the present invention via a communication line.

Detailed configuration and detailed operation of devices constituting the sales data processing device, the mobile terminal, and the sales data management system may be modified within the scope of the claims of the invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. A sales data processing device, comprising:
at least one processor that executes a program stored in memory, wherein
the at least one processor:
registers sales;
tries to transmit sales registration information of a registered transaction to an external terminal via a communicator based on timing of performing closing operation for the transaction; and
determines whether the sales registration information of the transaction is successfully transmitted, and
in a case where the at least one processor determines that transmission of the sales registration information of the transaction has failed, the at least one processor tries again to transmit the sales registration information of the transaction to the external terminal via the communicator based on timing of closing operation of a subsequent transaction.

2. The sales data processing device according to claim 1, wherein
in a case where the at least one processor determines that transmission of the sales registration information of the transaction has failed, the at least one processor tries again to transmit the sales registration information of the transaction; and
in a case where the at least one processor determines that retransmission of a preset number of times has failed, the at least one processor terminates the retransmission and tries again to transmit the sales registration information of the transaction to the external terminal via the communicator based on the timing of closing operation of the subsequent transaction.

3. The sales data processing device according to claim 2, wherein
the preset number of times is set for each period, and
the at least one processor terminates the retransmission in a case where the at least one processor determines that the retransmission of a number of times of the sales registration information has failed, the number of times corresponding to a period in which the transaction is performed.

4. The sales data processing device according to claim 3, wherein the preset number of times for each period is set according to busy status of respective periods at a store where the sales data processing device is installed.

5. The sales data processing device according to claim 4, wherein the preset number of times for each period is set according to numbers of transactions or customers in past periods at the store where the sales data processing device is installed.

6. The sales data processing device according to claim 5, wherein a smaller number of times is set for a period in which the number of transactions or customers is larger.

7. The sales data processing device according to claim 5, wherein
the numbers of transactions or customers in periods are classified into multiple levels; and
the number of times for each period is preset according to the levels such that a smaller number of times is set for a period in which the number of transactions or customers is at a higher level.

8. The sales data processing device according to claim 1, wherein, in a case where pieces of sales registration information of previous transactions have not been transmitted, before transmitting sales registration information of a transaction currently registered, the at least one processor performs control to transmit the pieces of sales registration information of the previous transactions one by one from oldest to newest.

9. The sales data processing device according to claim 2, wherein the at least one processor updates setting information of the number of times which is stored in the memory based on received setting information of the number of times.

10. The sales data processing device according to claim 4, wherein busy status of respective periods is derived based on sales registration information of a predetermined term.

11. The sales data processing device according to claim 5, wherein the numbers of transactions or customers in past periods is derived based on sales registration information of the predetermined term.

12. The sales data processing device according to claim 2, wherein, in a case where the at least one processor determines that the sales registration information of the transaction has been successfully transmitted, the at least one processor does not try again to transmit the sales registration information of the transaction.

13. The sales data processing device according to claim 1, wherein, while the at least one processor makes the communicator transmit the sales registration information of the transaction to the external terminal, the at least one processor displays a mark on a display, the mark indicating that communication with the external terminal is in progress.

14. A sales data processing method for a sales data processing device, comprising:
registering sales;
trying to transmit registered sales registration information of a transaction to an external terminal via a communicator based on timing of closing operation for the transaction;
determining whether the sales registration information of the transaction is successfully transmitted; and
in a case where it is determined that transmission of the sales registration information of the transaction has failed, trying again to transmit the sales registration information of the transaction to the external terminal via the communicator based on timing of closing operation of a subsequent transaction.

15. A non-transitory computer-readable recording medium storing a program that makes at least one processor of a sales data processing device:
register sales;
try to transmit sales registration information of a registered transaction to an external terminal via a communicator based on timing of closing operation for the transaction;
determine whether the sales registration information of the transaction is successfully transmitted; and
in a case where the at least one processor determines that transmission of the sales registration information of the transaction has failed, try again to transmit the sales registration information of the transaction to the external terminal via the communicator based on timing of closing operation of a subsequent transaction.
